(19) United States
(12) Patent Application Publication
(10) Pub. No.: US 2014/0021698 A1
(43) Pub. Date: Jan. 23, 2014

(54) Collapsible Cart for Transporting Bags

(71) Applicants: Nancy E. Beckman, Fresno, CA (US); Carl L. Beckman, Fresno, CA (US)

(72) Inventors: Nancy E. Beckman, Fresno, CA (US); Carl L. Beckman, Fresno, CA (US)

(21) Appl. No.: 13/555,181

(22) Filed: Jul. 22, 2012

(51) Int. Cl. B62B 3/02

(52) U.S. Cl. CPC B62B 3/027
USPC 280/651

(57) ABSTRACT

A cart for supportably transporting a plurality of bags by the handles of the bags when the bags have one or more items therein. The cart allows the user to easily transport full bags and, relative to standard carts, reduces the likelihood that the bags will spill. The cart has a collapsible frame assembly with a first frame member and a second frame member, a bag support assembly for receiving and retaining the bags, a handle for pushing the cart and a pair of wheel assemblies to allow the cart to move across a surface. The frame assembly is in a generally X-shaped configuration with one of the frame members configured to shorten or lengthen to place the cart in an upright position or a collapsed position. A pull pin is used to automatically fix the position of the cart and allow the user to raise or collapse the cart.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to carts, wagons and other apparatuses that are useful for carrying, transporting or otherwise moving a plurality of items from one place to another. More specifically, the present invention relates to carts and the like that are configured to easily transport shopping bags or bag-like containers having items therein. Even more specifically, the present invention relates to such carts that are collapsible for ease of use and storage.

B. Background

Many people utilize relatively small carts, wagons or other wheeled platforms, collectively these apparatuses are hereinafter referred to as “carts,” to move items, particularly heavy and/or bulky items or a plurality of small items, from one place to another. As generally well known, a wide variety of different types and configurations of carts are or can be utilized to transport such items. One common cart configuration is the standard shopping cart, which typically has a square or rectangular shaped, open top cage-like configuration that is mounted on a wheeled base with a rearwardly disposed handle which is utilized to push the shopping cart through the store while shopping for groceries and other items and into the store's parking lot to unload the purchased items into a vehicle. As well known, these shopping carts are usually configured with a relatively large item receiving area in which the loose items are placed while shopping in the store prior to paying for the items and in which bags or boxes containing the items are placed after checkout for ease of delivery of the items to the user's vehicle. In some relatively rare circumstances, the user utilizes the cart to deliver the items directly to his or her home or office. As well known, however, most stores do not allow carts to be taken from their parking lot area, thereby limiting the ability of most people to use the carts for home or office delivery. As such, standard shopping carts are also not available to assist persons with moving the items from their vehicle to inside the home or office where the items will be stored and/or used. Even if standard shopping carts were available to move the items into the home or office, they are generally much too bulky for easy manipulation in and out of the vehicle and to store in the home or office.

To assist with carrying items from the store to the vehicle and/or from the vehicle to inside the user's home or office, many stores provide plastic bags to place the items in after they are scanned and paid for during the checkout process. Alternatively, the person purchasing the items provides his or her own non-disposable, reusable bags to carry the items, typically in a desire to reduce the waste and other negative environmental impacts associated with the use of disposable plastic bags. In fact, as a result of such increased environmental awareness, the use of reusable shopping bags is becoming increasingly more common. One common feature of plastic disposable bags and typical reusable bags is that they usually have a handle that is configured to assist the user with transporting the bags, particularly when full of items. Although the handles of these bags are very useful when carrying the bags, the handles are not typically utilized by the user or in the cart when the bags are placed in the standard open top shopping cart. Instead, the full or partially full shopping bags are positioned inside the item receiving area of the shopping car, typically against the side walls of the cart and against each other in a manner that at least attempts to support the bags generally upright so the items will not spill out of the bags. As well known, however, attempts to maintain all of the bags in the preferred upright position is usually not entirely successful, such that at least some of the bags tip over and spill all or a portion of the previously contained items throughout the receiving area of the shopping cart.

Once to the vehicle, the user collects the spilled items, gathers the handles of each of the shopping bags, which by this time have typically fallen to the sides of and/or between the bags, and places each of the bags inside the vehicle. When the user gets home or to the office, he or she then grabs the bags, or just some of the bags if there are too many to carry all at once, and carries them inside. As can be readily appreciated by those skilled in the art, depending on how many bags there are and how full or heavy the bags are, the user may have to make multiple trips between the vehicle and the structure in order to transfer all of the shopping bags, and the items therein, to the interior of the structure. Naturally, if the person walked to the store and did not bring a cart or other carrying apparatus of their own, then he or she will generally have to manipulate the bags so that they, and the items therein, can all be carried in one trip, which depending on the weight of the items can be somewhat difficult to accomplish. As stated above, most stores do not allow their shopping carts to be transported out of the parking lot of the store.

Although the use of bags, whether disposable or reusable, are very common and generally becoming more common, particularly with regard to the “greener” reusable bags, there has been very little improvement in the way in which these bags are transported when they are full of items. Specifically, the standard shopping cart configuration has changed little to reflect the particular characteristics of shopping bags, namely soft sided containers that are relatively easily tipped over when placed and transported inside a standard shopping cart. As can be readily appreciated by persons who shop utilizing bags, whether reusable or not, while the handles of the bags are convenient for the user when carrying the bags, the handles are of little or no use when being transported in the standard shopping cart while shopping or when moving the items to the user's vehicle. As stated above, once the vehicle is driven to the home or office, the user does not have the shopping cart available and must, as a result, carry all of the bags, and the items therein, into the home or office themselves, either all at once or by making multiple trips.

What is needed, therefore, is an improved cart that is more useful for carrying and transporting items in bags, whether reusable or not. Specifically, what is needed is an improved cart that is configured to easily carry and transport one or more bags having handles and one or more items in the bag. The cart should be particularly structured and arranged to carry and transport the bags in a manner that substantially reduces, if not generally eliminates, the possibility of the bags spilling their contents while the user is carrying/transporting the bags and items therein. Preferably, the improved cart should be further structured and arranged to support a plurality of bags that each have one or more items therein and for ease of transport and storage when not being used to carry/transport bags. The improved cart should be relatively inexpensive to manufacture and easy to use.

### SUMMARY OF THE INVENTION

The collapsible cart for transporting bags of the present invention solves the problems and provides the benefits identified above. That is to say, the present invention discloses an improved cart that is specifically configured to allow the user thereof to easily and efficiently carry a plurality of shopping type bags, whether of the disposable or reusable type, that each have one or more items therein. The cart of the present invention is structured and arranged to support the bags by their handles so as to substantially reduce, if not generally eliminate, the possibility the bags will tip over and spill their contents while the user is transporting the bags, and the items therein, with the cart. The improved cart of the present invention is further structured and arranged to be collapsible for ease of transport and storage when the cart is not being used to transport bags full of items. In a preferred configuration of the present invention, the improved collapsible cart of the present invention is inexpensive to manufacture and easy to use.

In one general aspect, the improved cart of the present invention generally comprises a collapsible frame assembly, a bag support assembly, a first or front wheel assembly, a second or back wheel assembly and a handle that are cooperatively configured for assisting the user with transporting a plurality of bags that each have a handle attached thereto or integral therewith, particularly with one or more items in each of the bags. The frame assembly has a first frame member and a second frame member, with the frame assembly structured and arranged so as to place the first and second frame members in a generally X-shaped configuration. The frame assembly also has a frame collapsing mechanism that is configured to fixedly place the cart into either an upright position or a collapsed position and to allow the frame assembly to easily move between the upright and collapsed positions. The bag support assembly, which is attached to the frame assembly, is structured and arranged to receive and retain the handles of the bags so as to moveably transport the bags during use of the cart. The first wheel assembly is positioned generally at or towards a front end of the cart and the second wheel assembly is positioned generally at or towards a back end of the cart. Both wheel assemblies are configured for moving the cart across a surface, such as a floor, parking lot, driveway and the like. The handle is attached to the frame assembly generally at or towards the back end of the cart and is configured to allow the user to push the cart across the surface.

In the preferred embodiment, the frame assembly is foldably connected to the bag support assembly at or near the front end of the cart using a hinge or like apparatus and pivotally connected to the bag support assembly at or near the back end of the cart using a pivot pin or the like. The bag support assembly comprises at least one upper frame member attached to the frame assembly and at least one bag support mechanism that is attached to the upper frame member, with the bag support mechanism being structured and arranged to receive and retain the handle of the bags. In a preferred embodiment, the bag support mechanism comprises at least one generally U-shaped bracket. To allow the cart to easily move between its upright and collapsed positions, the first frame member comprises a first frame section and a tubular second frame section, with the first frame section being sized and configured to be linearly received in the second frame section. The frame collapsing mechanism has a pull pin that is configured to be received in a lower aperture in the first frame section so as to interconnect the first frame section and the second frame section and fixedly place the cart in the upright position and to be received in an upper aperture in the first frame section so as to interconnect the first frame section and the second frame section and fixedly place the cart in the collapsed position. In a preferred embodiment, the pull pin is configured to remain attached to the frame assembly when it is disengaged from each of the lower aperture and the upper aperture (i.e., when the user is moving the cart between the upright position and the collapsed position) so the pull pin will not get lost. The first wheel assembly and the second wheel assembly each comprises an elongated cross-member that has a wheel support mechanism at or near the ends thereof. Each of the wheel support mechanisms has a bracket that is attached to the cross-member and a wheel which is rotatably supported by the bracket. In one embodiment, the wheel support mechanism of the first wheel assembly is configured to allow the front wheels to swivel, whereas the wheels of the second wheel assembly are not allowed to swivel. Alternatively, the wheel support mechanism of the second wheel assembly can also be of the type that allows the wheels to swivel.

The cart of the present invention is particularly useful when moving a plurality of bags that are each filled with one or more items. For instance, the cart is structured and arranged to supportedly transport a plurality of shopping bags while the user moves through a store, from the store to his or her vehicle and/or from the vehicle to a home or office. The cart allows the user to transport bags in a manner that is much improved over standard shopping carts, the use of which frequently results in the bags tipping over and spilling the items placed therein. In addition, the cart of the present invention allows the user to supportably transport a plurality of shopping bags while he or she moves about an outdoor shopping area, mall, flea market, farmer's market or a variety of other locations where items may be gathered and standard carts are normally not available. Because the cart of the present invention is collapsible, the user will be able to take the cart to many locations where heretofore carts have not been available to assist the user with transporting bags full of items.

Accordingly, the primary objective of the present invention is to provide an improved cart that provides the advantages discussed above and which overcomes the disadvantages and limitations associated with presently available carts and like apparatuses for transporting a plurality of shopping type bags that each have one or more items therein.

It is also an important object of the present invention to provide an improved cart that is configured to allow the user to easily and efficiently transport one or more shopping bags, whether of the disposable or reusable type, that each have one or more items disposed therein.

It is also an important object of the present invention to provide an improved cart that is structured and arranged to supportedly transport a plurality of shopping bags by their handles while the bags have one or more items therein in a manner that substantially reduces the likelihood the bags will tip over and spill the items out of the bags.

It is also an important object of the present invention to provide an improved cart that is structured and arranged to supportedly transport a plurality of shopping bags while the user moves through the store, from the store to his or her vehicle and/or from the vehicle to the home or office.

It is also an important object of the present invention to provide an improved cart that has a frame assembly which is structured and arranged to be easily converted between an upright position to supportedly transport a plurality of shopping bags filled with items and a collapsed position for ease of handling and storage when not in use.

It is also an important object of the present invention to provide an improved cart that has a collapsible frame assembly which is structured and arranged to support a plurality of bags having items therein, a wheel assembly that is configured to allow the cart to be easily moved across a surface and a bag support assembly that supports the bags by their handles to substantially reduce the likelihood that the items will be spilled out of the bags.

Another important object of the present invention is to provide an improved cart that is structured and arranged to supportedly transport a plurality of shopping bags while the user moves about through an outdoor shopping area, mall, flea market, farmer's market or a variety of other locations where items may be gathered and carts are not normally available.

Yet another important object of the present invention is to provide an improved cart that is structured and arranged to supportedly transport a plurality of shopping bags without spilling the contents thereof that is easy to use and relatively inexpensive to manufacture.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a cart configured according to one of the preferred embodiments of the present invention shown in its upright position supporting a plurality of shopping bags that each have items therein;

FIG. 2 is a side perspective view of the cart FIG. 1 shown without the shopping bags;

FIG. 3 is a left side view of the cart of FIG. 2;

FIG. 4 is a right side view of the cart of FIG. 2;

FIG. 5 is a front end view of the cart of FIG. 2;

FIG. 6 is a back end view of the cart of FIG. 2;

FIG. 7 is a top plan view of the cart of FIG. 2;

FIG. 8 is a bottom plan view of the cart FIG. 2;

FIG. 9 is a right side view of the cart of FIG. 2 shown in its collapsed position; and

FIG. 10 is a right side view of the cart of FIG. 8 shown as it is being moved across a surface.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and the description set forth herein are primarily directed to a collapsible cart having a metal frame comprising two frame members and a pair of wheel assemblies that each have two wheels, persons skilled in the art will readily understand that this is merely for purposes of simplifying the present disclosure and that the present invention is not so limited.

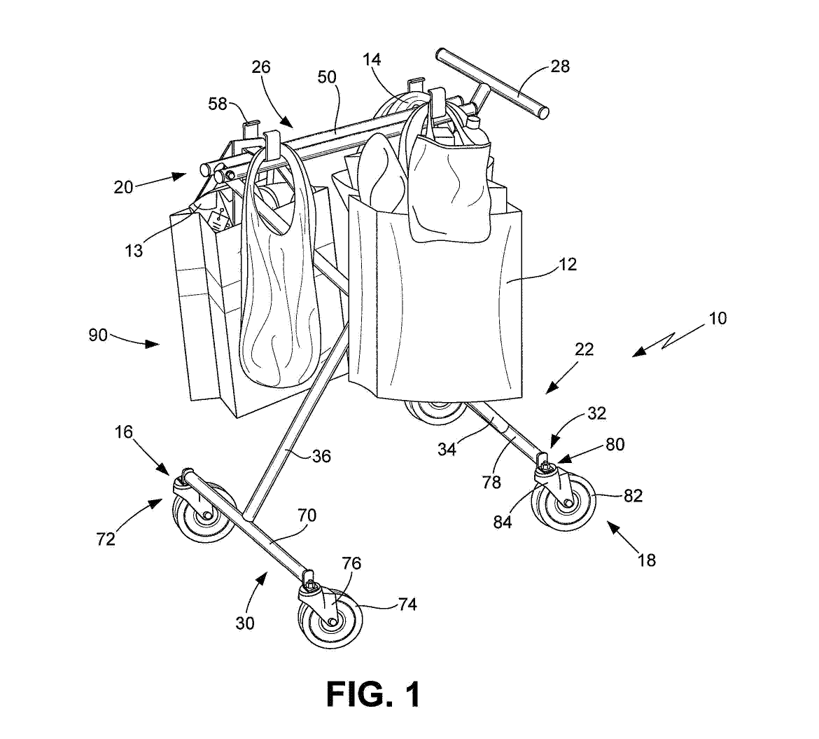

A cart that comprises the components which are structured and arranged pursuant to one or more embodiments of the present invention is shown generally as 10 in the figures. As shown in FIG. 1 and set forth in more detail below, cart 10 is configured to assist the user thereof to moveably support one or more bags 12 having items 13 generally disposed in the bags 12. Although cart 10 can be beneficially utilized to transport a variety of different types of bags 12, the typical bag 12 that will be utilized with cart 10 is the shopping bag type that has a handle 14 generally positioned at or near the top of the bag 12 where the bag 12 is at least substantially open to receive the items 13 in the item-storage compartment of bag 12. As explained below and shown in FIG. 1, each of the bags 12 are supported on the cart 10, with the items 13 disposed in the bags 12, by the handles 14. Because the bags 12 hang from the cart 10 by their handles 14 they do not need to lean against each other and/or the interior side walls of the standard shopping cart in order to remain upright and avoid spilling the items 13 inside the item receiving compartment of the standard shopping cart. Using cart 10 of the present invention, the bags 12 will not tip over, as is common with the prior art standard shopping cart, and the items 13 are much less likely to spill out of the bags 12, thereby reducing the potential for damage to the items 13 and the frustration or stress resulting from having to gather and re-bag the items 13.

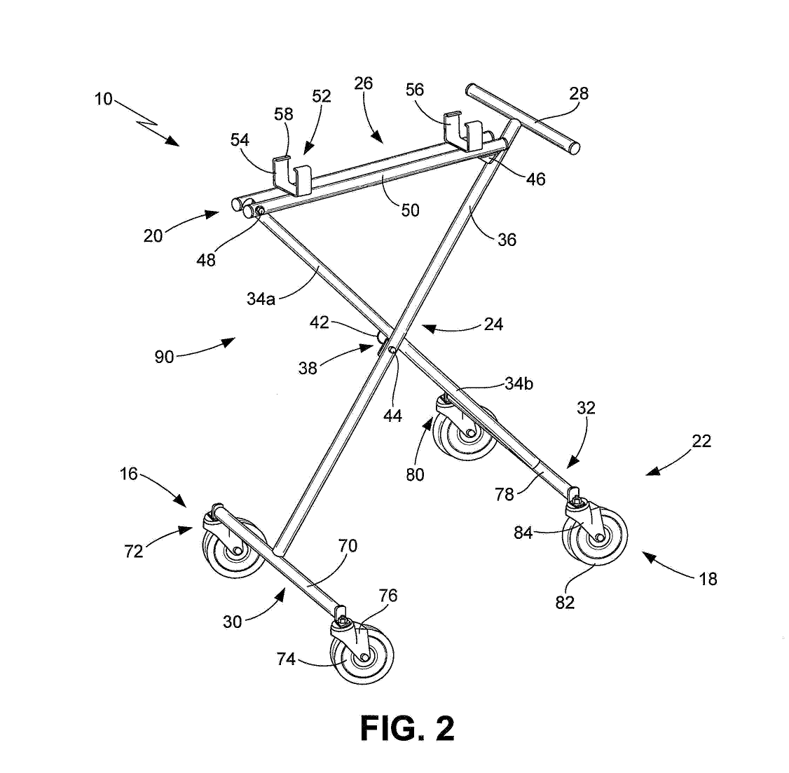

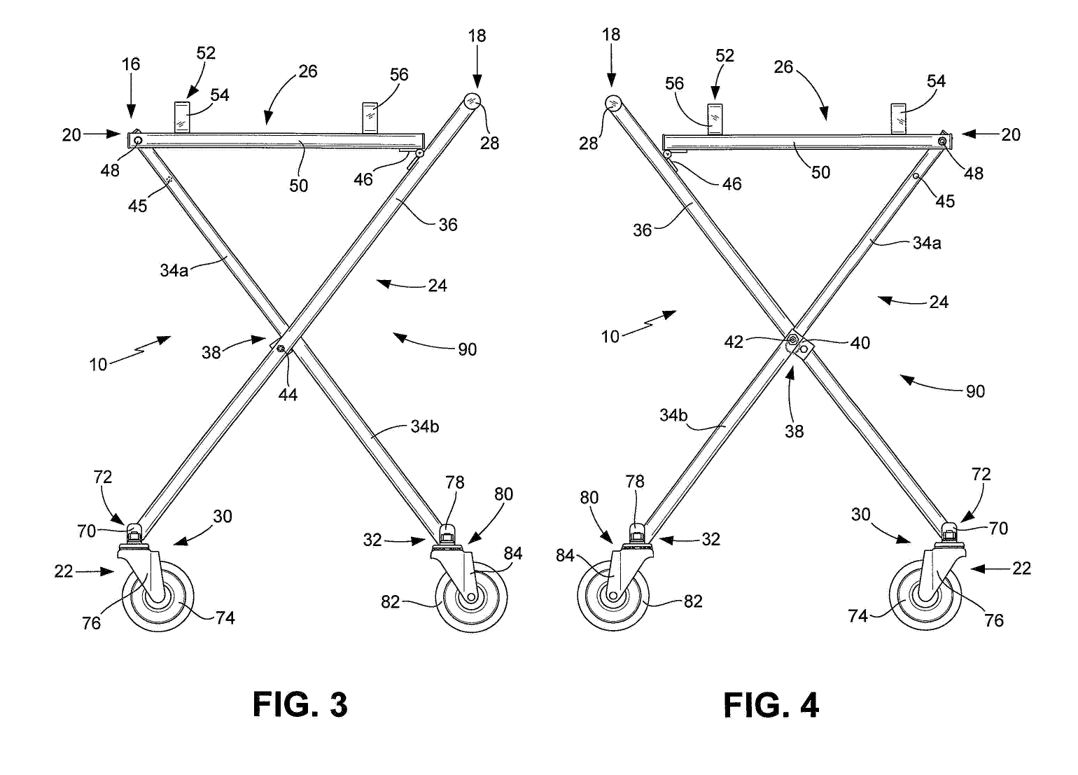

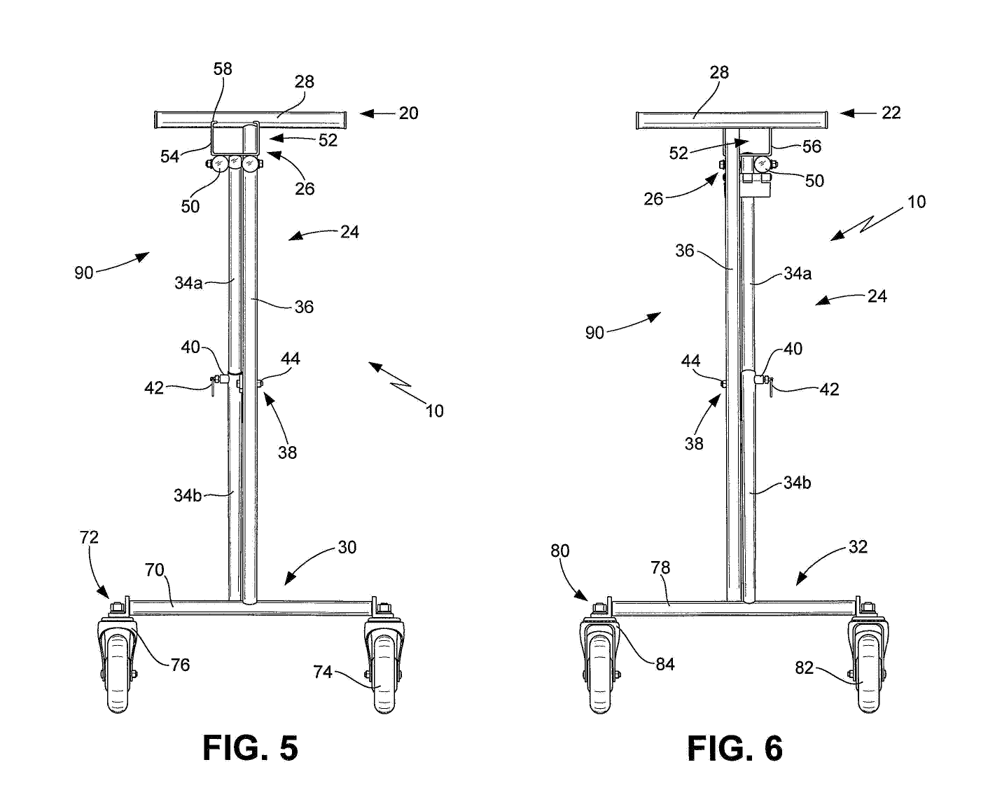

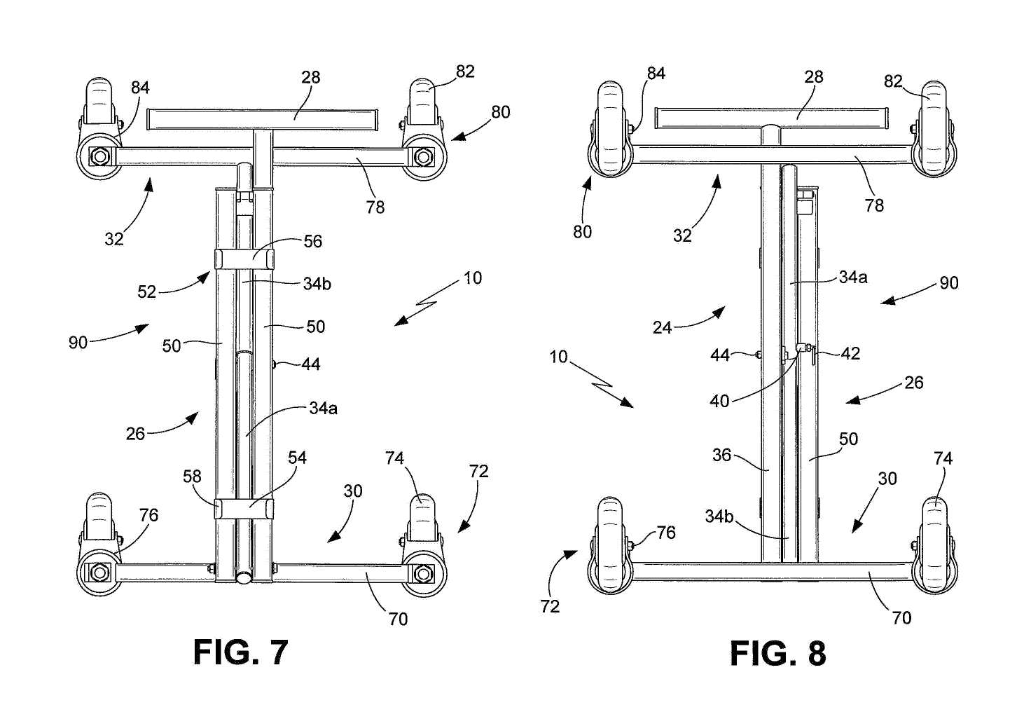

As best shown in FIGS. 1 through 8, the cart 10 has a first or front end 16, a second or back end 18, an upper end 20 and a lower end 22. As will be readily apparent to persons who are familiar with carts generally, the person using the cart 10 will stand behind the back end 18 of the cart 10 and push it across a floor, sidewalk, asphalt parking lot or other surface 23 (shown in FIG. 10) generally, but not exclusively, in a forward direction. The left side of cart 10, shown in FIG. 3, is identified from the perspective of the user standing at the back end 18 and facing in the same direction as the front end 16. Likewise, the right side of cart 10, shown in FIG. 4, is identified from this same perspective. As set forth in more detail below, the cart 10 generally comprises a collapsible frame assembly 24, a bag support assembly 26 that is attached to frame assembly 24 generally at or toward the upper end 20 of the cart 10, a handle 28 attached to the frame assembly 24 generally at or near the back end 18 of the cart 10, a first or front wheel assembly 30 at or near the front end 16 of cart 10 and a second or rear wheel assembly 32 at or near the back end 18 of cart 10, as best shown in FIGS. 2 through 8. The configuration and operation of the various components of cart 10 are explained in more detail below.

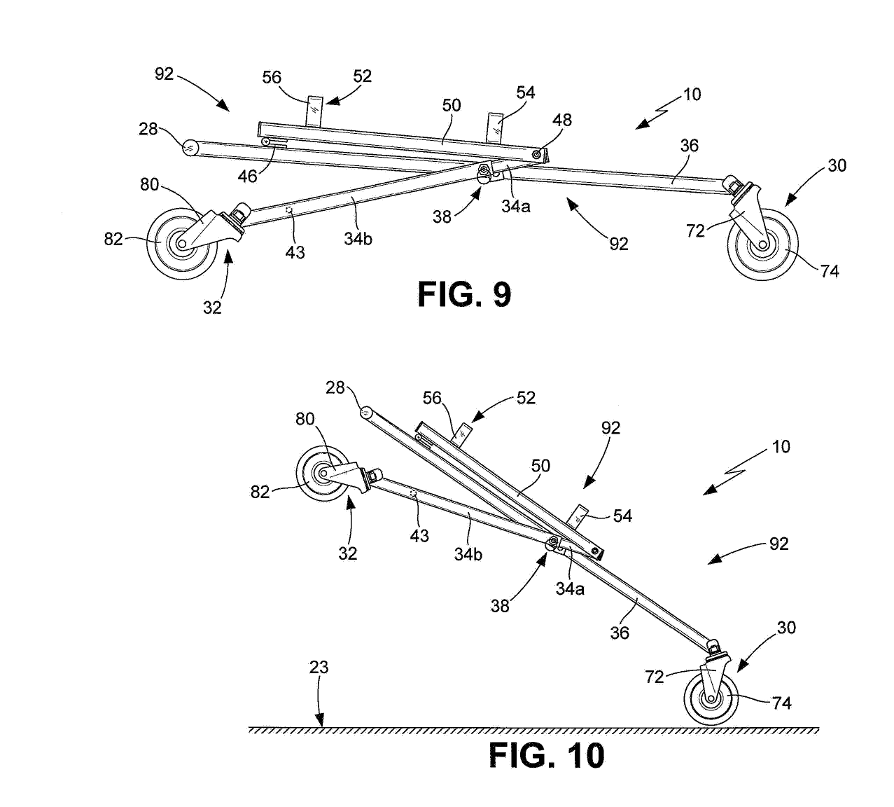

In the preferred embodiment of the cart 10 of the present invention, the components thereof are structured and arranged such that the user can easily and quickly switch cart 10 between its generally upright position 90, shown in FIGS. 1 through 8, and its generally folded or collapsed position 92, shown in FIGS. 9 and 10. As will be readily appreciated by those skilled in the art, in its upright position 90 the cart 10 can be pushed across a variety of surfaces 23 while supportably transporting one or more bags 12 that each have one or more items 13 therein. As shown in FIG. 1, the frame assembly 24 of cart 10 is sized and configured so the bags 12 can hang generally downward from their handles 14 so as to substantially reduce the likelihood the items 13 therein will spill from the bags 12 onto the surface 23 or elsewhere. As also will be readily appreciated by those skilled in the art, in its collapsed position 92 the cart 10 is much more convenient for moving cart 10, loading/unloading cart 10 into or out of the user's vehicle and storing cart 10 when not in use to moveably support one or more bags 12 having items 13 therein.

In the embodiment shown in the figures, collapsible frame assembly 24 generally comprises a first frame member 34, a second frame member 36 and a frame collapsing mechanism 38. As best shown in FIGS. 2 through 4, the first frame member 34 and second frame member 36 of the frame assembly 24 are placed in a generally X-shaped configuration. In one embodiment of cart 10, the first 34 and second 36 frame members are steel tubular members that are powder coated to reduce the likelihood of any corrosion from exposure to the elements. As will be readily appreciated by those skilled in the art, the frame members 34/36 can be integrally formed and be made out of a wide variety of tubular and/or non-tubular materials, including various metals such as steel, aluminum and the like or non-metal materials such as plastic, fiberglass, kevlar and other composites. The materials for the frame members 34/36 of frame assembly 24 should be selected to be able to safely support the anticipated loads from the bags 12 and items 13, withstand exposure to the environment and be light enough that the cart 10 can be easily manipulated by the user in and out of a vehicle and moved across a surface 23 while carrying the loads associated with the bags 12 and items 13. In addition, although the embodiment of cart 10 shown in the figures has only two frame members 34/36, those skilled in the art will readily appreciate that additional frame members can be utilized with cart 10.

In a preferred embodiment of the cart 10 of the present invention, the first frame member 34 comprises a first frame section 34a and a second frame section 34b, as best shown in FIGS. 2-4, with the second frame section 34b being tubular and the first frame section 34a being sized and configured to be linearly received in the second frame section 34b, as shown in FIGS. 9-10. The first frame section 34a will slide in and out of the second frame section 34b as the cart 10 moves between its upright position 90 and its collapsed position 92, as best shown relative to FIGS. 2 and 9. As explained in more detail below, the first frame section 34a comprises a lower aperture 43 which is engaged by the frame collapsing mechanism 38 to fix the frame assembly 24 so as to maintain the cart 10 in its upright position 90, as best shown in FIGS. 1-4, and an upper aperture 45 which is engaged by the frame collapsing mechanism 38 to fix the frame assembly 24 so as to maintain the cart 10 in its collapsed position 92. When neither aperture 43/45 is engaged by the collapsing mechanism 38, the first frame section 34a will freely slide in and out of the second frame section 34b to allow the user to easily position of the cart 10 in one of the upright position 90 or collapsed position 92.

In the preferred embodiment, the frame collapsing mechanism 38 is structured and arranged to allow the user to quickly and easily move between the upright 90 and collapsed 92 positions. The frame collapsing mechanism 38 must be configured to fixedly place cart 10 in its upright position 90 such that it will not unintentionally collapse while in use to moveably support the bags 12 and items 13 therein and will not unexpectedly and unintentionally “pop” to a generally open condition while the user is manipulating the cart 10 in or out of a vehicle or storing the cart 10 in a home or office. In the embodiment shown in the figures, the frame collapsing mechanism generally comprises a bracket 40 that is structured and arranged to interconnect frame section 34b and frame member 36 together so these two components will not move relative to each other. A bolt/nut, screw or other connector 44 can be utilized to secure the bracket 40 to one or more of frame members 34/36.

To fix the position of the cart 10 and prevent any movement of the frame assembly when the cart 10 is in either the upright position 90 or collapsed position 92, frame collapsing mechanism 38 also includes a device to lockedly engage the two frame sections 34a/34b. In the embodiment shown in the figures, a pull pin 42 type of device is utilized to lock the position 90/92 of cart 10. The pull pin 42 is received into apertures in the first frame section 34a, namely either a lower aperture 43 (best shown in FIGS. 9 and 10) or an upper aperture 45 (best shown in FIG. 4). Preferably, the pull pin 42 is structured and arranged such that the user merely has to slightly pull on the pull pin 42 to disengage it from either of the apertures 43/45 to release the locking of the frame sections 34a/34b so that the frame sections 34a/34b can be allowed to move freely to place the cart 10 in either its upright position 90 or in its collapsed condition 92. Also, it is preferred that the frame collapsing mechanism 38 be structured and arranged such that the pull pin 42 remains attached to the frame collapsing mechanism 38, although allowed to move inward and outward, so the pull pin 42 will not be lost when it is disengaged from the apertures 43/45. Although a removable pull pin 42 can be utilized with cart 10, persons skilled in the art will readily appreciated that a removable pull pin 42 is likely to get lost during use of cart 10, which will require the user to obtain a replacement pull pin 42 in order to continue to use cart 10. The non-separated pull pin 42 of the present invention stays with the cart 10 whether engaged in one of the apertures 43/45 to lock the cart 10 into either its upright position 90 or its collapsed position 92.

To facilitate the easy movement between the upright position 90 and the collapsed position 92, the collapsible frame assembly 24 of cart 10 includes a hinge 46 at or near the front end 16 of the cart 10 and a pivot pin 48 at or near the back end 18 thereof, as best shown in FIGS. 2-4 and 9. As shown in these figures, the hinge 46 foldably interconnects the second frame member 36 of the collapsible frame assembly 24 with one or more upper frame members 50 of the bag support assembly 26. The hinge 46, or an equivalent functioning device, folds or pivots the bag support assembly 26 lower against the second frame member 36 when the user collapses the frame assembly 24 to place cart 10 in its collapsed position 92 and allows the bag support assembly 26 to raise upward away from the second frame member 36 when the user places the cart 10 in its upright position 90. The pivot pin 48 pivotally connects the first frame member 34 with one or more of the upper frame members 50 of the bag support assembly 26. The pivot pin 48, or an equivalent functioning device, allows the bag support assembly 26 to pivot relative to the first frame member 34 when the user moves the cart 10 between its upright position 90 and its collapsed position 92 by either collapsing or unfolding the frame assembly 24.

As set forth above, the bag support assembly 26 is structured and arranged to provide structural support for the cart 10 when it is in its upright position 90 and to support one or more bags 12, each having one or more items 13 therein, by the handles 14 of the bags 12. The bag support assembly 26 of cart 10 generally comprises one or more upper frame members 50 connected to the frame assembly 24 and a bag support mechanism 52 attached to or integral with at least one of the upper frame members 50. The upper frame members 50, two of which are utilized in the embodiment shown in the figures, are beneficially structured and arranged to interconnect the frame members 34/36 of the frame assembly 24 in order to provide the necessary rigidity for the frame assembly 24 to allow cart 10 to stand in its upright position 90 while supporting one or more, typically a plurality of, bags 12 having items 13 therein. In one embodiment, the upper support members 50 are tubular steel members that are powder coated in a manner similar to the frame members 34/36. As with frame members 34/36, the upper support members 50 can be made out of a wide range of materials, including metals such as steel, aluminum and the like or non-metal materials such as plastic, fiberglass, kevlar and other composites. In the embodiment shown in the figures, the hinge 46 interconnects the two upper frame members 50 with the second frame member 36 and the pivot pin 48 interconnects the two upper frame members 50 with the first frame member 34, with the forward end of the first frame member 34 being pivotally disposed between the two upper frame members 50, as best shown in FIGS. 2, 5 and 7.

The bag support mechanism 52 of cart 10 is structured and arranged to support one or more, typically a plurality of, bags 12 by the handles 14. In the embodiment shown in the figures, the bag support mechanism 52 comprises two generally U-shaped brackets, namely a first U-shaped bracket 54 disposed generally at or towards the first or front end 16 of cart 10 and a second U-shaped bracket 56 disposed generally at or towards the second or back end 18 of cart 10. If desired, a single U-shaped bracket 54/56 can be utilized with the bag support mechanism 52 or more than two of the U-shaped brackets 54/56 can be utilized, depending on the number of bags 12 desired to be transported by cart 10 and the ability of cart 10 to support those bags 12 and the items 13 therein. As shown in FIG. 1, the U-shaped brackets 54/56 are sized and configured to receive and retain the handles 14 of the desired number of bags 12 and support the bags 12 in a hanging arrangement on either side of the cart 10. The actual size of the U-shaped brackets 54/56 are likely to depend on the size, type and number of bags 12 which are desired to be supported on cart 10. In one embodiment, the inventors have found that U-shaped brackets 54/56 having a base width of approximately three inches and vertical height of approximately two inches is generally sufficient for most shopping bags 12 and the items 13 likely to be in those bags 12. As with the other components of cart 10, the U-shaped brackets 54/56 can be made out of a variety of materials as long as the material is strong enough to support the desired bags 12 and capable of being attached to the upper frame members 50. In one embodiment, the U-shaped brackets 54/56 are made out of steel that is powder coated to reduce the chance of corrosion and to improve the aesthetics of the brackets 54/56. However, aluminum and various other metals or non-metal materials such as plastic, fiberglass, kevlar and other composites can also be utilized for U-shaped brackets 54/56.

The shape of the generally U-shaped brackets 54/56 should be selected so as to be able to easily receive and remove the handles 14 of the bags 12 therefrom and to retain those bags 12 on the cart 10, as shown in FIG. 1. In the embodiment shown in the figures, the vertical portions of each U-shaped bracket 54/56 have a curved upper end 58, as best shown in FIGS. 1, 2 and 7, that is curved generally inward (i.e., toward each other) to assist in retaining the bags 12 on in the U-shaped brackets 54/56. In the embodiment of the U-shaped brackets 54/56 described above, the upper ends 58 curve inward approximately one-half inch. Depending on the size of the U-shaped brackets 54/56, the gap between the two curved upper ends 58, the width or other size consideration of the handles 14 of the bags 12 that are to be utilized with cart 10 and the desired ease or difficulty desired with regard to removal of the bags 12 from the cart 10, the size of the curved upper ends 58 can be adjusted accordingly.

As stated above, the handle 28 is positioned generally toward the back end 18 of the cart 10 when cart 10 is in its upright position, as best shown in FIGS. 1-4. Preferably, handle 28 is fixedly attached or integral with one or more members of the collapsible frame assembly 24 and/or the bag support assembly 26. In the embodiment shown in the figures, the handle 28 is a straight bar-like tubular member that is at the upper end, when cart 10 is in its upright position 90, of the second frame member 36 and sized and configured to allow the user to grip his or her hands around the handle 28 while pushing cart 10, whether when in use with bags 12 as shown in FIG. 1, when empty of bags 12 as shown in FIG. 2, or when it is in its collapsed position 92 as shown in FIG. 10. As will be readily appreciated by those skilled in the art, a wide variety of different shapes, sizes and materials can be utilized for handle 28. In one embodiment, the handle 28 is made from one inch tubular steel that is powder coated. If desired, various hand grips, which are generally well known in the art, can be utilized with handle 28 for the comfort and improved grip of the user.

To facilitate movement about the surface 23, shown in FIG. 10, the cart 10 of the present invention comprises a first or front wheel assembly 30 at or near the first/front end 16 of the cart 10 and a second or back wheel assembly 32 at or near the second/back end 18 of cart 10, as best shown in FIGS. 1-4 and 9-10. As best shown in FIGS. 1-2 and 5, first wheel assembly 30 comprises an elongated cross-member 70 that is fixedly attached to or integral with the lower end, when cart 10 is in its upright position 90, of second frame member 36 so as to generally perpendicular thereto. In one embodiment, the cross-member 70 is a one inch tubular steel member approximately sixteen inches in length. At each of the outer ends of the cross-member 70 is positioned a wheel support mechanism 72 comprising a wheel 74 that is rotatably supported by a bracket 76, which connects to the cross-member 70. The wheels 74 are selected to rotatably move across surface 23 when the user desires to move the cart 10 in either its upright position 90 or collapsed position 92 (as shown in FIG. 10). In one embodiment, the wheels 74 have solid rubber tires. Bracket 76 is configured to allow the wheel 74 associated therewith to freely rotate. In the embodiment shown in the figures, each of the brackets 76 are of the type that allows the wheel 74 to swivel relative to the end of the cross-member 70. The configuration and uses of such wheels 74 and brackets 76 are well known in the art of moveable carts (including the prior art standard shopping cart), chairs and the like.

As best shown in FIGS. 1-2 and 6, second/back wheel assembly 32 comprises an elongated cross-member 78 that is fixedly attached to or integral with the lower end, when cart 10 is in its upright position 90, of the first frame member 34 so as to generally perpendicular thereto. In one embodiment, the cross-member 78 is a one inch tubular steel member approximately sixteen inches in length. At each of the outer ends of the cross-member 78 is positioned a wheel support mechanism 80 comprising a wheel 82 that is rotatably supported by a bracket 84, which connects to the cross-member 78. The wheels 82 are selected to rotatably move across surface 23 when the user desires to move the cart 10 in its upright position 90. As shown in FIG. 10, typically the wheels 82 of the second wheel assembly 32 do not contact the surface 23 when the user is moving the cart 10 across the surface 23 in its collapsed position 92. In one embodiment, the wheels 82 have solid rubber tires. Bracket 84 is configured to allow the wheel 82 associated therewith to freely rotate. In the embodiment shown in the figures, the brackets 84 do not allow the wheels 82 to swivel. As with the first wheel assembly 30, the configuration and uses of such wheels 82 and brackets 84 are well known in the art of moveable carts (including the prior art standard shopping cart), chairs and the like.

In the preferred configuration of the cart 10 of the present invention, the materials and method of manufacturing and assembling the components for cart 10 are selected so as to provide an easy to use cart 10 (i.e., one that is strong but lightweight and which moves easily) that is relatively inexpensive to manufacture and, therefore sell. In one embodiment, each of the various frame members 34/36, upper frame members 50, handle 28 and cross-members 70/78 are made from one inch tubular steel that is powder coated or otherwise treated to reduce the likelihood of corrosion and improve its appearance. The U-shaped brackets 54/56 and wheel support mechanisms 72/80 are “off-the-shelf” items to further keep the cost of manufacturing cart 10 relatively low. Use of steel or the like allows common and relatively inexpensive welding to be utilized to fixedly connect the components together.

In use, the cart 10 is normally in its collapsed position 92 when it is not in use, such as when the cart 10 is being stored or being transported to the store or other location where the cart 10 will be utilized to carry one or more bags 12. With the pull pin 42 engagedly received in upper aperture 45, the collapsed generally X-shaped frame assembly 24 will keep cart 10 in the collapsed position 92, as shown in FIG. 9, making storage and movement of the cart 10 relatively easy. Between the home/office and vehicle and between the vehicle and store, or otherwise not in use to carry bags 12, the cart 10 can be pushed around in the collapsed position 92 on its front wheel assembly 30, as shown in FIG. 10. When the user is at the store, he or she will move the cart 10 to its upright position 90 by pulling on the pull pin 42 to pull it out of the upper aperture 45 to disengage the frame collapsing mechanism 38 so the frame assembly 24 can be un-folded or un-collapsed, typically by pulling generally upward or outward on the bag support assembly 26 and/or handle 28 to cause the first frame section 34a to slide out of the second frame section 34b and to allow the two frame members 34/36 to move upward. When the cart 10 is fully in its upright position 90, as shown in FIG. 2, the pull pin 42 will engage the lower aperture 43 to lock the two frame sections 34a/34b relative to each other so as to fix the generally X-shape of the frame assembly 24. The user places the handles 14 of the various bags 12 on the U-shaped brackets 54/56 of the bag support assembly 26 and the items 13 are placed in the bags 12. With the items 13 in the bags 12, as shown in FIG. 1, the user can push the cart 10 around on surface 23 to move the bags 12 and items 13 to the vehicle and from the vehicle to the interior of the home or office. Once the bags 12 are unloaded from cart 10, the user then pulls on the pull pin 42 to disengage the pull pin 42 from the lower aperture 43 so the frame section 34a can slide back into frame section 34b, typically by the user pushing down on the bag support assembly 26 and/or handle 28 to collapse the frame assembly 24 and place the cart 10 in its collapsed position 92, as shown in FIG. 9. The pull pin 42 will automatically engage the upper aperture 45 to lock the cart 10 in its collapsed position 92 so it may be moved, as shown in FIG. 10.

As will be readily appreciated by those skilled in the art, the cart 10 of the present invention will be particularly useful when moving a plurality of bags 10 filled with items 13. For instance, the cart 10 is structured and arranged to supportedly transport a plurality of shopping bags 10 while the user moves through a store, from the store to his or her vehicle and/or from the vehicle to a home or office. The cart 10 transports bags 12 full of items 13 in a manner that is much improved over standard shopping carts, the use of which frequently results in the bags 12 tipping over and spilling the items 13. In addition, the cart 10 also allows the user to supportedly transport a plurality of shopping bags 12 while he or she moves about an outdoor shopping area, mall, flea market, farmer's market or a variety of other locations where items 13 may be gathered and carts are not normally available. The collapsible nature of the cart 10 of the present invention will allow the user to take the cart 10 to many locations where heretofore carts have not been available to assist the user.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A cart for transporting a plurality of bags that each have a handle attached thereto or integral therewith, said cart comprising:
a frame assembly having a first frame member and a second frame member, said frame assembly structured and arranged so as to place said first frame member and said second frame member into a generally X-shaped configuration;
a frame collapsing mechanism associated with said frame assembly, said frame collapsing mechanism configured to fixedly place said cart into one of an upright position and a collapsed position and to allow said frame assembly to move between said upright position and said collapsed position;
a bag support assembly attached to said frame assembly, said bag support assembly structured and arranged to receive and retain said handles of said bags so as to moveably transport said bags;
a first wheel assembly generally at or towards a front end of said cart for moving said cart across a surface;
a second wheel assembly generally at or towards a back end of said cart for moving said cart across said surface; and
a handle attached to said frame assembly generally at or towards said back end of said cart, said handle configured to move said cart across said surface when said cart is in at least said upright position.

2. The cart of claim 1, wherein said frame assembly is foldably connected to said bag support assembly at or near said front end of said cart and pivotally connected to said bag support assembly at or near said back end of said cart.

3. The cart of claim 2 further comprising a hinge foldably connecting said bag support assembly to said second frame member and a pivot pin pivotally connecting said bag support assembly to said first frame member.

4. The cart of claim 1, wherein said bag support assembly comprises at least one upper frame member attached to said frame assembly and at least one bag support mechanism attached to said upper frame member, said bag support mechanism structured and arranged to receive and retain said handle of at least one of said bags.

5. The cart of claim 4, wherein said bag support mechanism comprises at least one generally U-shaped bracket.

6. The cart of claim 1, wherein said first frame member comprises a first frame section and a tubular second frame section, said first frame section sized and configured to be linearly received in said second frame section, said frame collapsing mechanism comprising a pull pin configured to be received in a lower aperture in said first frame section so as to interconnect said first frame section and said second frame section and fixedly place said cart in said upright position and to be received in an upper aperture in said first frame section so as to interconnect said first frame section and said second frame section and fixedly place said cart in said collapsed position.

7. The cart of claim 6, wherein said pull pin is configured to remain attached to said frame assembly when disengaged from each of said lower aperture and said upper aperture when moving said cart between said upright position and said collapsed position.

8. The cart of claim 1, wherein each of said first wheel assembly and said second wheel assembly comprises an elongated cross-member having a wheel support mechanism at or near each end thereof, each of said wheel support mechanisms having a bracket attached to said cross-member and a wheel rotatably supported by said bracket.

9. A cart for transporting a plurality of bags that each have a handle attached thereto or integral therewith, said cart comprising:
a frame assembly having a first frame member and a second frame member disposed in a generally X-shaped configuration, said first frame member comprising a first frame section and a tubular second frame section, said first frame section sized and configured to be linearly received in said second frame section;
a frame collapsing mechanism associated with said frame assembly and configured to selectively engage each of said first frame section and said second frame section of said first frame member, said frame collapsing mechanism configured to fixedly place said cart into one of an upright position and a collapsed position and to allow said frame assembly to move between said upright position and said collapsed position;
a bag support assembly attached to said frame assembly, said bag support assembly structured and arranged to receive and retain said handles of said bags so as to moveably transport said bags, said bag support assembly having at least one upper frame member attached to said frame assembly and at least one bag support mechanism attached to said upper frame member, said bag support mechanism structured and arranged to receive and retain said handle of at least one of said bags;
a first wheel assembly generally at or towards a front end of said cart for moving said cart across a surface, said first wheel assembly comprising an elongated cross-member having a wheel support mechanism at or near each end thereof, each of said wheel support mechanisms having a bracket attached to said cross-member and a wheel rotatably supported by said bracket;
a second wheel assembly generally at or towards a back end of said cart for moving said cart across said surface, said second wheel assembly comprising an elongated cross-member having a wheel support mechanism at or near each end thereof, each of said wheel support mechanisms having a bracket attached to said cross-member and a wheel rotatably supported by said bracket; and
a handle attached to said frame assembly generally at or towards said back end of said cart, said handle configured to move said cart across said surface when said cart is in at least said upright position.

10. The cart of claim 9, wherein said frame assembly is foldably connected to said bag support assembly at or near said front end of said cart and pivotally connected to said bag support assembly at or near said back end of said cart.

11. The cart of claim 10 further comprising a hinge foldably connecting said bag support assembly to said second frame member and a pivot pin pivotally connecting said bag support assembly to said first frame member.

12. The cart of claim 9, wherein said bag support mechanism comprises at least one generally U-shaped bracket.

13. The cart of claim 9, wherein said frame collapsing mechanism comprises a pull pin configured to be received in a lower aperture in said first frame section so as to interconnect said first frame section and said second frame section and fixedly place said cart in said upright position and to be received in an upper aperture in said first frame section so as to interconnect said first frame section and said second frame section and fixedly place said cart in said collapsed position.

14. The cart of claim 13, wherein said pull pin is configured to remain attached to said frame assembly when disengaged from each of said lower aperture and said upper aperture so as to allow linear movement of said first frame section in said second frame section when moving said cart between said upright position and said collapsed position.

15. A cart for transporting a plurality of bags that each have a handle attached thereto or integral therewith, said cart comprising:
a frame assembly having a first frame member and a second frame member, said frame assembly structured and arranged so as to place said first frame member and said second frame member into a generally X-shaped configuration, said first frame member comprising a first frame section and a tubular second frame section, said first frame section sized and configured to be linearly received in said second frame section;
a frame collapsing mechanism associated with said frame assembly and configured to selectively engage each of said first frame section and said second frame section of said first frame member, said frame collapsing mechanism configured to fixedly place said cart into one of an upright position and a collapsed position and to allow said frame assembly to move between said upright position and said collapsed position, said frame collapsing mechanism comprising a pull pin configured to be received in a lower aperture in said first frame section so as to interconnect said first frame section and said second frame section and fixedly place said cart in said upright position and to be received in an upper aperture in said first frame section so as to interconnect said first frame section and said second frame section and fixedly place said cart in said collapsed position
a bag support assembly attached to said frame assembly, said bag support assembly structured and arranged to receive and retain said handles of said bags so as to moveably transport said bags, said bag support assembly having at least one upper frame member attached to said frame assembly, a first U-shaped bracket attached to said upper frame member towards a front end of said cart and a second U-shaped bracket attached to said upper frame member towards a back end of said cart, each of said first U-shaped bracket and said second U-shaped bracket sized and configured to receive and retain said handle of at least one of said bags;
a first wheel assembly generally at or towards said front end of said cart for moving said cart across a surface, said first wheel assembly comprising an elongated cross-member having a wheel support mechanism at or near each end thereof, each of said wheel support mechanisms having a bracket attached to said cross-member and a wheel rotatably supported by said bracket;
a second wheel assembly generally at or towards said back end of said cart for moving said cart across said surface, said second wheel assembly comprises an elongated cross-member having a wheel support mechanism at or near each end thereof, each of said wheel support mechanisms having a bracket attached to said cross-member and a wheel rotatably supported by said bracket; and
a handle attached to said frame assembly generally at or towards said back end of said cart, said handle configured to move said cart across said surface when said cart is in at least said upright position.

16. The cart of claim 15, wherein said pull pin is configured to remain attached to said frame assembly when disengaged from each of said lower aperture and said upper aperture so as to allow linear movement of said first frame section in said second frame section when moving said cart between said upright position and said collapsed position.

17. The cart of claim 15, wherein said frame assembly is foldably connected to said bag support assembly at or near said front end of said cart and pivotally connected to said bag support assembly at or near said back end of said cart.

18. The cart of claim 17 further comprising a hinge foldably connecting said bag support assembly to said second frame member and a pivot pin pivotally connecting said bag support assembly to said first frame member.
